(19) United States
(12) Patent Application Publication
(10) Pub. No.: US 2025/0104894 A1
(43) Pub. Date: Mar. 27, 2025

(54) DOWNSIZED VARIABLE INDUCTOR

(71) Applicants: CHEONGJU UNIVERSITY INDUSTRY & ACADEMY COOPERATION FOUNDATION, Cheongju-si (KR); TRANSON CO., LTD, Seoul (KR)

(72) Inventors: Heung Gyoon CHOI, Suwon-si (KR); Yong Won KIM, Gwangmyeong-si (KR)

(73) Assignees: CHEONGJU UNIVERSITY INDUSTRY & ACADEMY COOPERATION FOUNDATION, Cheongju-si (KR); TRANSON CO., LTD, Seoul (KR)

(21) Appl. No.: 18/819,553

(22) Filed: Aug. 29, 2024

(30) Foreign Application Priority Data
Sep. 27, 2023 (KR) 10-2023-0130147

(51) Int. Cl. H01F 3/14; H01F 1/34; H01F 21/00

(52) U.S. Cl. CPC H01F 3/14; H01F 1/34; H01F 21/00

(57) ABSTRACT

A downsized variable inductor is disclosed. The downsized variable inductor includes: a magnetic core formed in a closed loop shape, and including an air gap portion formed by partially opening the closed loop shape; a gap core inserted and fixed to the air gap portion to be integral with the magnetic core, and served to increase an inductance and a maximum current at low current of the inductor, and a coil wound and connected to the magnetic core.

### CROSS REFERENCE TO RELATED APPLICATION

The present application claim priority to Korean Patent Application No. 10-2023-0130147, filed Sep. 27, 2023, the entire contents of which are incorporated herein for all purposes this reference.

### BACKGROUND

### Technical Field

The present disclosure relates to a downsized variable inductor.

### Description of Related Technology

In general, an inductor is a coil that induces a voltage proportional to a change in electric current. The inductor is one of the most important components of an electrical circuit, along with a resistor, a capacitor, an electron tube, a transistor, a power source, and the like. A solenoid-type inductor, which is made of copper or aluminum wrapped in insulating material and wound several times in a threaded shape, is mainly used. In other words, a coil with wires is the most basic circuit component and circuit element.

Passive elements such as an inductor, as well as a resistor and a capacitor, have fixed values that do not change. Fixed values for passive elements can be an advantage, but sometimes they can also be a disadvantage. For example, an inductor, which is a magnetic element often used in power conversion circuits such as a DC-DC converter and a DC-AC inverter, often has a fixed inductance value. The main roles of the inductor in the power conversion circuit are current smoothing, current suppression, energy storage, and filtering to remove a high-frequency component of a voltage and a current caused by switching of a semiconductor switching device such as an insulated-gate bipolar transistor (IGBT) and a MOS field-effect transistor (MOSFET).

However, in the case of a power converter using a conventional constant inductor value, high efficiency can be achieved at a medium load, but efficiency is greatly reduced at a light load. In addition, when considering a miniaturization of a product, a conventional inductor is not able to meet the miniaturization of a power converter, and the application range of the inductor is too limited

Korean Patent Application Publication NO. 10-2017-0040984 (published on 2017 Apr. 14) may be referred to as a prior art document.

### SUMMARY

The present disclosure is to provide a downsized variable inductor with simultaneously increased inductance at a low current and higher current.

### Means for Solving Problems

In accordance with an aspect of the present disclosure, a downsized variable inductor is disclosed.

A downsized variable inductor according to an embodiment of the present disclosure, includes: a magnetic core formed in a closed loop shape, and including an air gap portion formed by partially opening the closed loop shape; a gap core inserted and fixed to the air gap portion to be integral with the magnetic core, and served to increase an inductance at low current and a higher current of the inductor; and a coil wound and connected to the magnetic core.

The gap core includes: a permanent magnet formed to correspond to a shape of the air gap portion and having a through-hole formed in a central portion thereof; and an auxiliary magnetic core inserted and fixed in the through-hole.

The magnetic core is formed of a first magnetic material, and the auxiliary magnetic core is formed of a second magnetic material dissimilar to the first magnetic material.

The first magnetic material is Mn—Zn ferrite and the second magnetic material is Mn—Fe ferrite or magnetic material with different properties from Mn—Zn ferrite.

The magnetic core is formed to have the closed loop shape with two E-shaped cores joined.

According to an embodiment of the present disclosure, the downsized variable inductor can be miniaturized and lightened due to an increase in direct current superposition characteristics by simultaneously increasing inductance at a low current and maximum current, and can improve efficiency by reducing losses in the circuit to which the inductor is applied.

### BRIEF DESCRIPTION OF THE DRAWINGS

FIGS. 1 and 2 schematically illustrate configurations of a downsized variable inductor according to an embodiment of the present disclosure.

FIG. 3 schematically illustrates a DC-DC converter circuit with a downsized variable inductor according to the embodiment of the present disclosure.

FIGS. 4 and 5 show an inductance and an efficiency of the downsized variable inductor according to the embodiment of the present disclosure, respectively, compared to other inductors.

### DETAILED DESCRIPTION

Singular expressions in the present specification include plural expressions unless the context clearly indicates otherwise. As used herein, the terms “consisting” or “including” and the like should not be construed as necessarily including all of the various components or steps described in the specification, some of which may not be included, or additional components or steps may be further included. In addition, a term such as a “portion” or a “module” used in the specification means a unit that handles at least one function or operation, which may be implemented in hardware or software, or may be implemented as a combination of hardware and software.

Hereinafter, various embodiments of the present disclosure will be described with reference to the accompanying drawings.

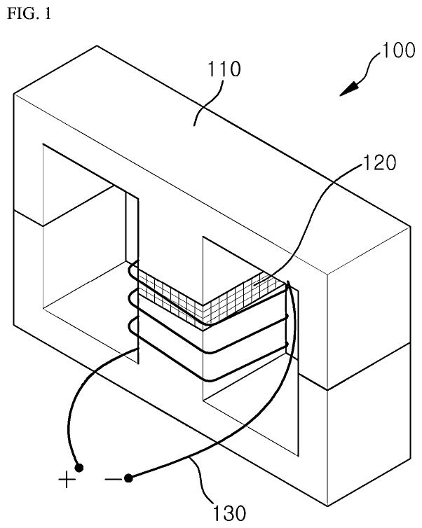

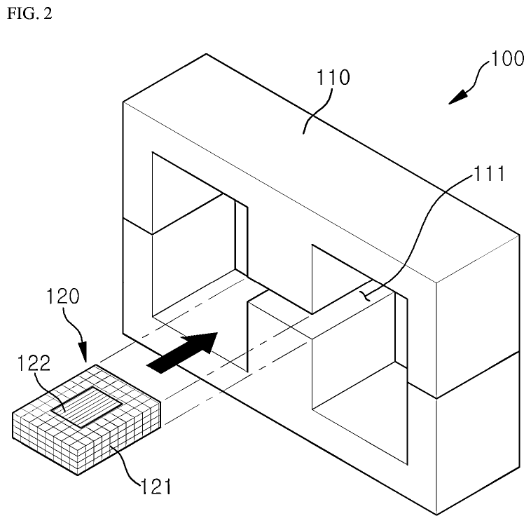

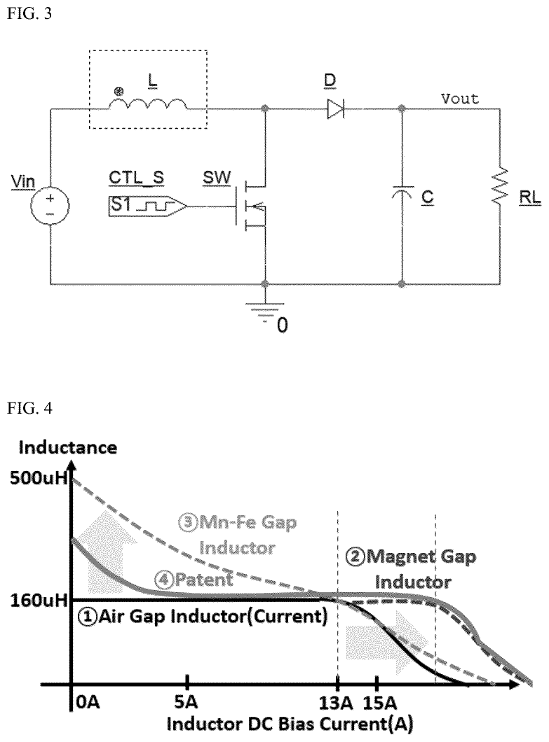

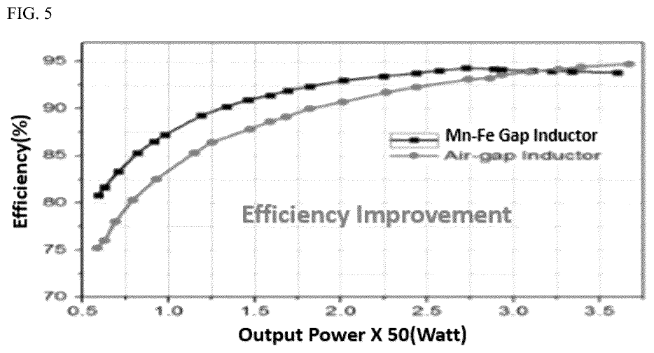

FIGS. 1 and 2 schematically illustrate configurations of a downsized variable inductor according to an embodiment of the present disclosure. FIG. 3 schematically illustrates a DC-DC converter circuit with a downsized variable inductor according to the embodiment of the present disclosure. FIGS. 4 and 5 show an inductance and an efficiency of the downsized variable inductor according to the embodiment of the present disclosure, respectively, compared to other inductors. Hereinafter, with reference to FIGS. 1 to 5, a downsized variable inductor according to the embodiment of the present disclosure will be described.

Referring to FIGS. 1 and 2, a downsized variable inductor 100 according to the embodiment of the present disclosure may include a magnetic core 110, a gap core 120, and a coil 130.

The magnetic core 110 is formed of a first magnetic material, and may be formed to have a closed loop shape with two E-shaped cores joined. For example, the first magnetic material may be a Mn—Zn ferrite.

Further, the magnetic core 110 includes an air gap portion 111 formed by partially opening the closed loop shape.

In other words, as shown in FIG. 2, the air gap portion 111 may be formed in a center portion among the portions where the two E-shaped cores engage in the magnetic core 110. For example, the center portion of the E-shaped core may be made short by a predetermined length to form the air gap portion.

The gap core 120 is inserted and fixed into the air gap portion 111 formed in the magnetic core 110 so as to become integral with the magnetic core 110, thereby increasing an inductance at low current and a maximum current of the downsized variable inductor 100 according to the embodiment of the present disclosure.

Referring to FIG. 2, the gap core 120 includes a permanent magnet 121 and an auxiliary magnetic core 122.

The permanent magnet 121 may be formed corresponding to the shape of the air gap portion 111 formed in the magnetic core 110, as shown in FIG. 2, and a through-hole (not shown) may be formed in the center portion into which the auxiliary magnetic core 122 is inserted.

The permanent magnet 121 may increase a direct current superposition characteristic of the downsized variable inductor 100 according to the embodiments of the present disclosure, thereby increasing the maximum current of the inductor 100.

The auxiliary magnetic core 122 may be formed from a second magnetic material that is dissimilar to the first magnetic material forming the magnetic core 110, and may be inserted into and secured to the through-hole formed in the center portion of the permanent magnet 121. For example, the second magnetic material may be a Mn—Fe ferrite.

The auxiliary magnetic core 122 may increase a low current inductance of the downsized variable inductor 100 according to embodiments of the present invention.

The coil 130 is wound and connected to the portion of the magnetic core 110 where the air gap portion 111 is formed, i.e., where the gap core 120 is located, as shown in FIGS. 1 and 2.

A DC-DC converter shown in FIG. 3 may be coupled with a power conversion circuit. In such a power conversion circuit, when a magnitude of a bias current applied to the coil 130 of the downsized variable inductor 100 according to the embodiment of the present disclosure applied to the DC-DC converter is adjusted, an inductance may be changed according to the magnitude of the adjusted bias current.

In FIG. 4, No. 1 represents a change in an inductance of an inductor with only the air gap portion 111 formed, No. 2 represents a change in an inductance of an inductor with only the permanent magnet 121 applied to the air gap portion 111, No. 3 represents a change in an inductance of an inductor with the auxiliary magnetic core 122, such as Mn—Fe ferrite, applied to the air gap portion 111, and No. 4 represents a change in an inductance of the downsized variable inductor 100 according to the embodiment of the present disclosure.

Referring to FIG. 4, the inductor of No. 1 has the same inductance as the bias current is varied, and the maximum bias current at which the inductance appears is small. Further, the inductor of No. 2 has the same inductance as the bias current is varied, and the maximum bias current at which the inductance appears is 1.8 times larger than the inductor of No. 1. Further, in the inductor of No. 3, the inductance of the inductor increases as the bias current decreases. In addition, the downsized variable inductor 100 of No. 4 according to the embodiment of the present disclosure, such as the one incorporating the inductors of No. 2 and No. 3, has an inductance that increases as the bias current decreases, but the maximum bias current at which the inductance increases is 1.8 times higher than that of No. 1.

On the other hand, referring to FIG. 5, the inductor of No. 3 in which the auxiliary magnetic core 122, such as Mn—Fe ferrite, has been applied to the air gap portion 111 has a better efficiency for output power than the inductor of No. 1 in which only the air gap portion 111 has been formed. This means that the downsized variable inductor 100 according to the embodiment of the present disclosure can also have an increased inductance at light loads due to the insertion of the auxiliary magnetic core 122, which is a different magnetic material than the magnetic core 110, and thus improve efficiency through loss reduction.

When the downsized variable inductor 100 according to the embodiment of the present disclosure is applied to a product, the size of the inductor product is reduced by about 32% and the efficiency is expected to be increased by 5% (losses are reduced by 5%).

For example, the downsized variable inductor 100 according to the embodiment of the present disclosure can be applied to an inductor of a power factor correction circuit (PFC) in a power supply of an LED/OLED TV, a transformer for a flyback converter in a power supply of an audio, an inductor of a power factor correction circuit (PFC) in an on board charger (OBC) of an electric vehicle (EV), etc.

The above embodiments of the present disclosure have been disclosed for the purpose of examples, and those skilled in the art can make various changes, modifications, or additions within the spirit and scope of the present invention, and it should be understood that such changes, modifications, or additions also belong to the scope of the present disclosure.

### DESCRIPTION OF REFERENCE NUMERALS

100: downsized variable inductor
110: magnetic core
111: air gap portion
120: gap core
121: permanent magnet
122: auxiliary magnetic core
130: coil

What is claimed is:

1. A downsized variable inductor comprising:
a magnetic core formed in a closed loop shape, and including an air gap portion formed by partially opening the closed loop shape;
a gap core inserted and fixed to the air gap portion to be integral with the magnetic core, and served to increase an inductance at low current and a maximum current of the inductor; and
a coil wound and connected to the magnetic core.

2. The downsized variable inductor of claim 1, wherein the gap core includes:
a permanent magnet formed to correspond to a shape of the air gap portion and having a through-hole formed in a central portion thereof; and
an auxiliary magnetic core inserted and fixed in the through-hole.

3. The downsized variable inductor of claim 2, wherein the magnetic core is formed of a first magnetic material, and the auxiliary magnetic core is formed of a second magnetic material dissimilar to the first magnetic material.

4. The downsized variable inductor of claim 3, wherein the first magnetic material is Mn—Zn ferrite and the second magnetic material is Mn—Fe ferrite.

5. The downsized variable inductor of claim 1, wherein the magnetic core is formed to have the closed loop shape with two E-shaped cores joined.
